(19) United States
(12) Patent Application Publication
(10) Pub. No.: US 2013/0183643 A1
(43) Pub. Date: Jul. 18, 2013

(54) AUDIBLE DICTIONARY DEVICE

(71) Applicants: Aderonke AKINSAYNA, Millbrook, AL (US); Sodjidassi AZIADAPOU, Millbrook, AL (US)

(72) Inventors: Aderonke AKINSAYNA, Millbrook, AL (US); Sodjidassi AZIADAPOU, Millbrook, AL (US)

(21) Appl. No.: 13/350,392

(22) Filed: Jan. 13, 2012

(51) Int. Cl. G09B 19/00

(52) U.S. Cl. 434/156

(57) ABSTRACT

The present invention is an audible dictionary device that includes an attached pointer, an on and off switch, a volume control switch, a keyboard that includes a shift button and a delete button that is utilized to delete a previous usage history of one or more words researched or looked-up. The device also includes an audio speaker that emits any sounds that would include one or more words or other suitable verbiage and one or more meanings that are requested by the user, a submit button that is used to submit or enter any word or suitable combination of words that the audible dictionary device would give one or more meanings or definitions to, a language switch button that controls a language that the words entered and their the meanings would be emitted and pronounced and a screen display that displays the words and their the definitions.

### TECHNICAL FIELD & BACKGROUND

Traditionally, dictionaries are paperback or hardcover, and are often heavy to carry. Currently there are limited alternatives to reference devices that are electronic that have the capability to be utilized as a dictionary.

The present invention generally relates to a dictionary. More specifically, the invention is an audible dictionary device.

It is an object of the invention to provide an audible dictionary device that is to provide a lightweight and portable dictionary.

It is an object of the invention to provide an audible dictionary device that is relatively compact and audible.

It is an object of the invention to provide an audible dictionary device that also provides a relatively simple glossary.

What is really needed is an audible dictionary device that is to provide a lightweight and portable dictionary that is relatively compact and audible and that also provides a relatively simple glossary.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of an audible dictionary device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

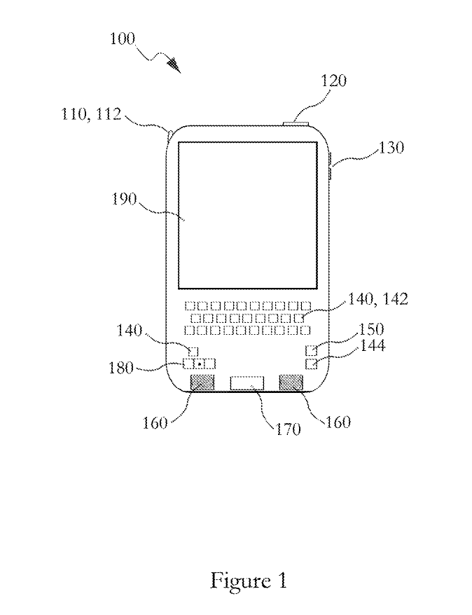

FIG. 1 illustrates a front view of an audible dictionary device 100, in accordance with one embodiment of the present invention. The audible dictionary device 100 provides a lightweight and portable dictionary that is relatively compact and audible and that also provides a relatively simple glossary. The audible dictionary device 100 is made of plastic but can be made of any suitable material such as metal as well.

The audible dictionary device 100 includes an attached pointer 110, an on and off switch 120, a volume control switch 130, a keyboard 140, a delete button 150, an audio speaker 160, a submit button 170, a language switch button 180 and a screen display 190.

The attached pointer 110 is located inside of a holder (not shown) to use as a touch screen 112 on the audible dictionary device 100. The on and off switch 120 can be any suitable on and off switch such as a toggle switch 122 to turn the audible dictionary device 100 on and off. The volume control switch 130 can be any suitable type of volume control switch and is utilized to control the volume of the audible dictionary device 100. The keyboard 140 is typically a QWERTY keyboard 142 but can be any suitable keyboard type and includes a shift button 144 to control capitalization of letters and other suitable characters disposed on a keyboard 140. The delete button 150 is utilized to delete any previous usage history of words researched or looked-up. The audio speaker 160 emits any sounds that would include words or other suitable verbiage and their one or more meanings that are requested by the user. The submit button 170 is used to submit or enter any word or suitable combination of words that the audible dictionary device 100 would give one or more meanings to. The language switch 180 controls the language that the words entered and their meaning would be emitted and pronounced. The screen display 190 displays the words and their definitions and serves as a touch screen selection surface. The audible dictionary device 100 has a generally rectangular shape, with dimensions of approximately 6 inches long and 4 inches wide. The audible dictionary device 100 is energy efficient, crafted to be solar powered 192 with a back-up rechargeable battery 194.

The audible dictionary device incorporates a relatively easily navigable touch screen with one or more convenient windows to display each word and one or more of its subsequent definition. The audible dictionary device is readily available wherever electronic devices are sold in various colors and designs. The audible dictionary device has the ability of audibly communicating the definition of an unknown entered word. The design of the audible dictionary device not only features a touch screen, but incorporates a key pad for dual functionality and a sleek pointer for use on the touch screen, preventing smudges.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An audible dictionary device, comprising:
an attached pointer that is located inside of a holder;
an on and off switch to turn said audible dictionary device on and off;
a volume control switch;
a keyboard and includes a shift button to control capitalization of one or more letters and one or more other suitable characters disposed on said keyboard;
a delete button that is utilized to delete a previous usage history of one or more words researched or looked-up;
an audio speaker that emits any sounds that would include one or more words or other suitable verbiage and one or more meanings that are requested by said user;
a submit button that is used to submit or enter any word or suitable combination of words that said audible dictionary device would give one or more meanings or definitions to;
a language switch button that controls a language that said words entered and their said meanings would be emitted and pronounced; and
a screen display that displays said words and their said definitions.

2. The device according to claim 1, wherein said attached pointer is used as a touch screen on said audible dictionary device.

3. The device according to claim 1, wherein said screen display serves as a touch screen selection surface.

4. The device according to claim 3, wherein said screen display is a touch screen with one or more convenient windows to display each word and one or more said definitions.

5. The device according to claim 1, wherein said on and off switch is a toggle switch.

6. The device according to claim 1, wherein said keyboard is a QWERTY keyboard.

7. The device according to claim 1, wherein sad audible dictionary device is generally rectangular shaped.

8. The device according to claim 1, wherein said audible dictionary device is solar powered.

9. The device according to claim 1, wherein said audible dictionary device is provided with a back-up rechargeable battery.

10. The device according to claim 1, wherein said audible dictionary device is made of plastic.

11. A generally rectangular shaped audible dictionary device, comprising:
an attached pointer that is located inside of a holder;
an on and off switch to turn said audible dictionary device on and off;
a volume control switch;
a keyboard and includes a shift button to control capitalization of one or more letters and one or more other suitable characters disposed on said keyboard;
a delete button that is utilized to delete a previous usage history of one or more words researched or looked-up;
an audio speaker that emits any sounds that would include one or more words or other suitable verbiage and one or more meanings that are requested by said user;
a submit button that is used to submit or enter any word or suitable combination of words that said audible dictionary device would give one or more meanings or definitions to;
a language switch button that controls a language that said words entered and their said meanings would be emitted and pronounced; and
a screen display that displays said words and their said definitions serves as a touch screen selection surface.

12. The device according to claim 11, wherein said attached pointer is used as a touch screen on said audible dictionary device.

13. The device according to claim 12, wherein said screen display is said touch screen with one or more convenient windows to display each word and one or more said definitions.

14. The device according to claim 11, wherein said on and off switch is a toggle switch.

15. The device according to claim 11, wherein said keyboard is a QWERTY keyboard.

16. The device according to claim 11, wherein said audible dictionary device is solar powered.

17. The device according to claim 11, wherein said audible dictionary device is provided with a back-up rechargeable battery.

18. The device according to claim 11, wherein said audible dictionary device is made of plastic.

19. The device according to claim 11, wherein said audible dictionary device is made of metal.

20. The device according to claim 11, wherein said audible dictionary device is approximately 6 inches long and 4 inches wide.
